(19) United States
(12) Patent Application Publication
(10) Pub. No.: US 2002/0029087 A1
(43) Pub. Date: Mar. 7, 2002

(54) Slim digital audio player and recorder with cradle

(76) Inventors: Douglas Mayne, Ogden, UT (US); David E. Jones, Layton, UT (US)

Correspondence Address: Michael K. Jones, Woodcock Washburn Kurtz, Mackiewicz & Norris LLP, One Liberty Place - 46th Floor, Philadelphia, PA, 19103, US

(21) Appl. No.: 09/755,399

(22) Filed: Jan. 5, 2001

Related U.S. Application Data
(60) Provisional application No. 60/230,892, filed on Sep. 5, 2000.

(51) Int. Cl. G06F 17/00

(52) U.S. Cl. 700/94

(57) ABSTRACT

A combination of a digital audio player and recorder and a cradle. The digital audio player and recorder comprises: a data storage device capable of receiving a data storage medium; a printed circuit assembly (PCA) connected to the data storage device, a housing enclosing the data storage device and the PCA, and a first connector extending through the housing and connected to the PCA for transferring data between the cradle and the data storage device. The cradle comprises a receptacle adapted to receive the player and recorder, a second connector adapted to detachably couple with the first connector, and a third connector adapted to detachably couple with an external data source.

### FIELD OF THE INVENTION

The invention relates to a portable listening device. In particular, the invention relates to a slim digital audio player and recorder and an accompanying cradle.

### BACKGROUND OF THE INVENTION

With the introduction of the MP3 music format, music has become easier to distribute and play. The MP3 format is a compression system that reduces the amount of space an audio data file occupies on a storage medium without significantly altering the quality of the information stored therein. Accordingly, a song in the MP3 format sounds nearly the same as a song recorded in an uncompressed format such as, for example, on a compact disk yet requires less storage space on a storage medium. Therefore, because a song requires less storage space on a storage medium, it becomes easier and faster to distribute and store the music.

Consequently, devices that record and play MP3 formatted data (i.e. MP3 players) have become popular. Particularly, portable MP3 players have become popular. As with any portable device, size and weight are significant factors in determining how convenient the device is to transport. Therefore, there is a need to develop a smaller and more convenient portable MP3 player and recorder.

### SUMMARY OF THE INVENTION

The invention satisfies the aforementioned need by moving certain functionality and the components that carry out such functionality from an MP3 player/recorder to a separate device called a cradle. By moving these components, the player/recorder becomes smaller in size and lighter in weight. Therefore, the player/recorder becomes more convenient to carry.

The invention is a combination of a digital audio player and recorder for playing and recording digital data, and a cradle for receiving the digital audio player and recorder. The digital audio player and recorder includes a data storage device capable of receiving a data storage medium, a printed circuit assembly (PCA) connected to the data storage device, a housing enclosing the data storage device and the PCA and a first connector extending through the housing and connected to the PCA for transferring data between the cradle and the data storage device.

The invention also includes the cradle that includes a receptacle adapted to receive the player and recorder, a second connector adapted to detachably couple with the first connector and a third connector adapted to detachably couple with an external data source.

In accordance with another embodiment of the invention, the data storage device is a disk drive that is capable of receiving a data storage cartridge or disk and reading and recording digital data to the data storage cartridge or disk. Also, the digital audio player and recorder further include a power source such as rechargeable battery.

In accordance with another embodiment of the invention, a cradle is provided that receives and holds a digital audio player and recorder and transfers data to and from the digital audio player and recorder. The cradle includes functional components that are conventionally disposed within a player and recorder that are not necessary for accessing the data or playing back the audio data on the player/recorder.

In accordance with another embodiment of the invention, a digital audio player and recorder is provided having a slim form factor. Such form factor is smaller than conventionally digital audio player and recorders because certain components that do not aid in the playback of audio data are moved from the player/recorder to a separate cradle.

### BRIEF DESCRIPTION OF THE DRAWINGS

Other features of the invention are further apparent from the following detailed description of the invention taken in conjunction with the accompanying drawings, of which:

FIG.1 is a perspective view of an exemplary player/recorder and cradle in accordance with the invention;

FIG. 2 is a block diagram illustrating in an exemplary manner the interaction of an external data source, a cradle, a player/recorder, a data storage device and data storage medium in accordance with the invention;

FIG. 3 is a perspective view of the player/recorder of FIG. 1 in accordance with the invention;

FIG. 4 is a top view of the recorder/player of FIG. 3;

FIG. 5 is a bottom view of the recorder/player of FIG. 3;

FIG. 6 is an exploded view of the recorder/player of FIG. 3;

FIG. 7 is a perspective view of the cradle of FIG. 1 in accordance with the invention;

FIG. 8 is a cross section of the cradle in FIG. 7 taken along sectional lines 8-8;

FIG. 9 is a rear view of the cradle of FIG. 7;

FIG. 10 is a top view of the cradle of FIG. 7; and

FIG. 11 is a bottom view of the cradle of FIG. 7.

### DETAILED DESCRIPTION OF THE INVENTION

In the invention, a digital audio player and recorder and a cradle are used in conjunction to transfer, play and/or store digital data, such as audio, video, and the like. In accordance with the invention, the cradle contains components conventionally disposed within a player/recorder that are not necessary for accessing the data or playing back the audio data on the player/recorder. Therefore, by placing these components in a separate cradle, the player/recorder becomes lighter and more compact, and thus easier to carry when removed from the cradle.

The cradle and player/recorder are electrically connected when the player/recorder is placed in the cradle. The player/recorder and the cradle can be detached from each other, so, for example a user may separately transport the player/recorder and the cradle. The connection between the cradle and the player/recorder allows for the transfer of data between an external data source, such as a personal computer, and a storage medium in the player/recorder. In addition, the connection provides electrical power to the player/recorder and may recharge the power source in the player/recorder when the player/recorder is in the cradle. The player/recorder can be removed from the cradle and used to play the digital data stored in a storage medium that has been inserted into the player/recorder or otherwise stored in the player/recorder.

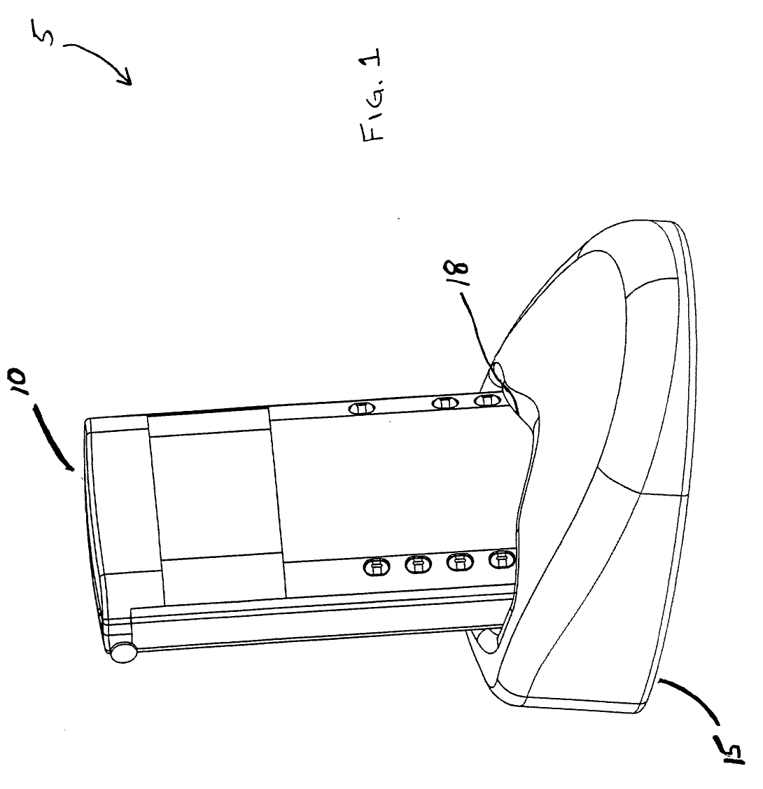

Referring to the drawings wherein like numerals represent like elements throughout, there is shown in FIG. 1 a system 5 for playing and recording data in a digital format in accordance with the invention. The system 5 is a combination comprising a digital audio player/recorder 10 and a cradle 15. As shown, cradle 15 is adapted to physically receive and hold player/recorder 10 by means of a receptacle 18 in the cradle 15.

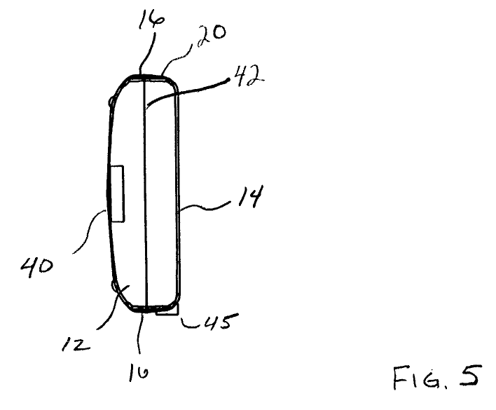

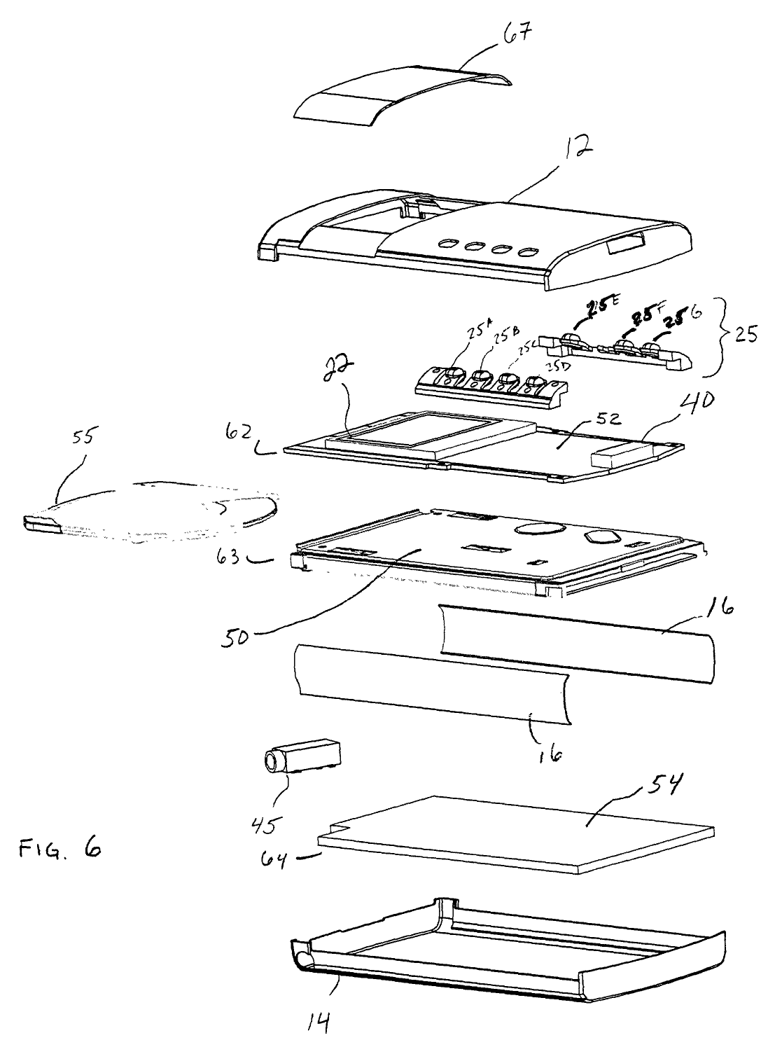

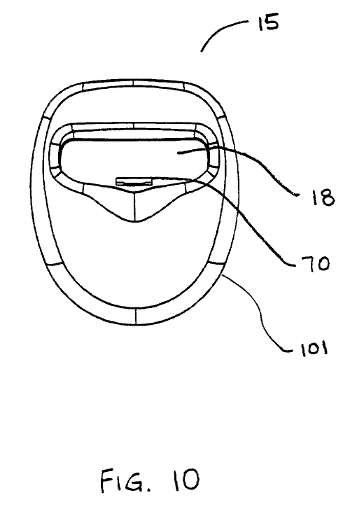

Player/recorder 10 and cradle 15 each have an electrical connector (see FIG. 5 and FIG. 10). When player/recorder 10 is inserted into receptacle 18, the connector on the player/recorder 10 and the connector on the cradle 15 mate to provide an electrical connection there between. The mated connectors can be used to transfer data between the cradle 15 and the player/recorder 10, and to and from an external data source (not shown) that may be connected to the cradle 15. The mated connectors also transfer power from the cradle 15 to the power source (see FIG. 6). In this sense, the power is used to recharge the power source in the player/recorder 10.

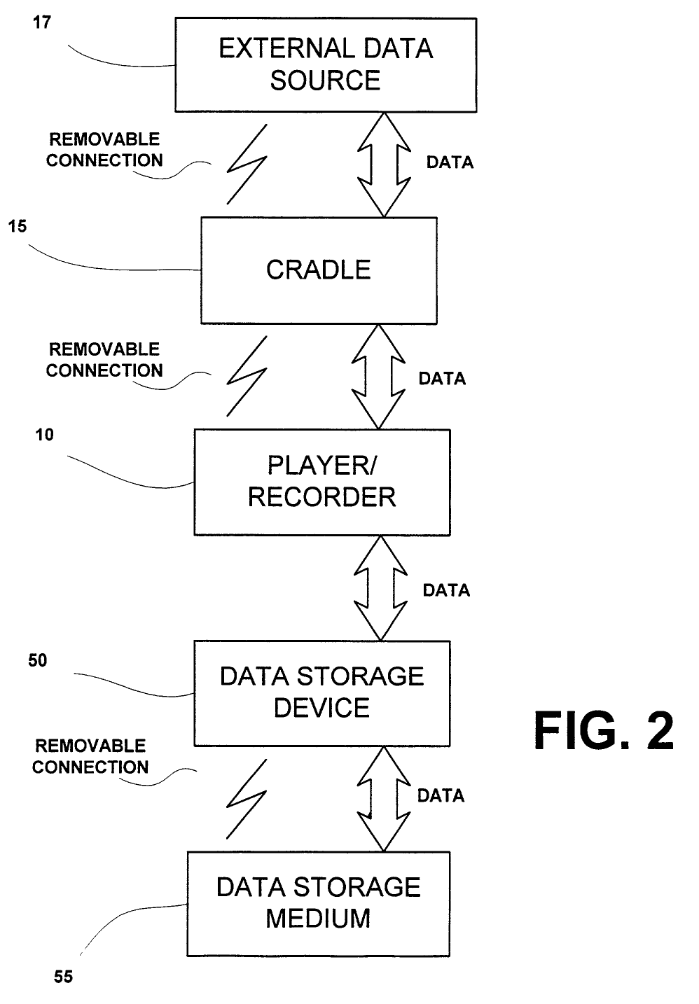

FIG. 2 is a block diagram illustrating in an exemplary process for transferring digital data between an external data source, a cradle, a player/recorder, a data storage device and data storage medium in accordance with the invention. In particular, FIG. 2 shows the directional flow of data in the system 5. Data flows between the external data source 17 and the data storage medium 55. In one embodiment of the invention, data may flow from a data storage medium 55, such as a magnetic disk to an external data source 17, such as a personal computer, via a data storage device 50, a player/recorder 10 and a cradle 15. Likewise, in another embodiment of the invention, data may flow from the external data source 17 to the data storage medium 55 via a cradle 15, a player/recorder 10 and a data storage device 50. In yet another embodiment of the invention and as shown in FIG. 2, data flows in both directions, i.e. from the external data source 17 to the data storage medium 55 and from the data storage medium 55 to the external data source 17.

In order to transfer data (in either direction), the data storage medium 55 is inserted into the data storage device 50 of the player/recorder 10. The player/recorder 20 is then inserted into cradle 15 that is connected to an external data source 17.

FIG. 2 also shows components that may be removably connected to one another. In particular, the data storage medium 55 may be removably connected to the data storage device 50. The player/recorder 10 may be removably connected to the cradle 15. The cradle 15 may also be removably connected to the external data source 17.

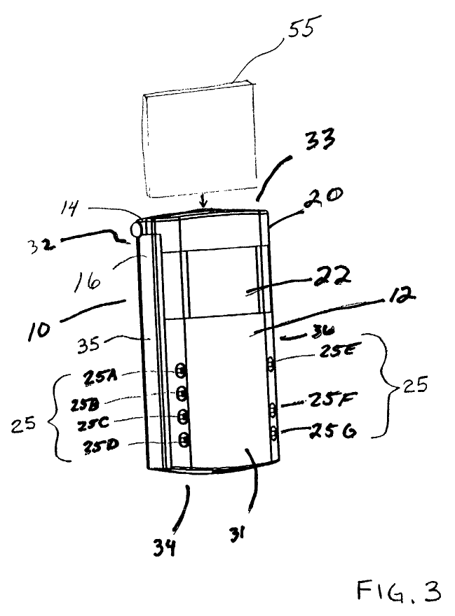

FIG. 3 is a perspective view of the player/recorder of FIG. 1 in accordance with the invention. Player/recorder 10 has a housing 20 with a front 31, back 32, top 33, bottom 34, left 35 and right 36 side. As shown, the housing 20 is substantially rectangular, however, the shape of the housing can be any shape without departing from the scope of the invention.

The housing has a face plate 12, a back plate 14. In one embodiment, the housing also includes at least one side plate 16. In this manner, the face plate 12 and back plate 14 are positioned together in a planar fashion and define a receptacle there between. The face plate 12 and back plate 14 can be fastened together using the at least one side plate 16. In one embodiment, a pressure sensitive adhesive may be used to secure the side plate 16 to the face plate 12 and back plate 14 to form the housing 20. In another embodiment, the side plate can be snapped to the face plate 12 and the back plate 14 to form the housing 20. The at least one side plate may also be riveted or screwed to the face plate 12 and back plate 14 thus securing the housing 20.

In one embodiment, the face plate 12 and back plate 14 are made of aluminum, however, many different materials, such as, for example, plastic or the like can be used for the front plate and back plate without departing from the principles of the invention. In one embodiment, the side plates 16 are made of stainless steel or rubber, however, many other materials may be used without departing from the invention.

As shown in FIG. 3, there are several features on the exterior of the housing 20 of the player/recorder 10. As shown, a display screen 22, such as, for example, a liquid crystal display (LCD) screen, is disposed on the face plate 12 of the player/recorder 10. The display screen 22 displays information to the user of the player/recorder 10. Information may include, for example, the title of the song currently playing, the song time remaining, track number etc. Other information may be displayed without departing from the scope of the invention.

Control buttons 25 are also disposed on the exterior of the housing 20 of the player/recorder 10. Control buttons 25 are used to control the playing and recording of audio data. As shown, the control buttons 25 include a stop button 25A, a play button 25B, a forward button 25C, a reverse button 25D, menu/select button 25E and a scroll buttons 25F, 25G (e.g. up and down arrow). In one embodiment of the invention, the control buttons are carbon contacts, however, other button types, such as, for example, push buttons may be used without departing from the scope of the invention. The location and layout of the various control buttons 25 may vary without departing from the scope of the invention.

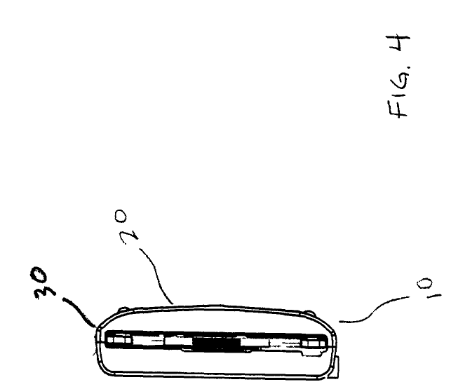

FIG. 3 also shows a data storage medium 55. The data storage medium 55 can be removably inserted into the player/recorder 10. As shown, in one embodiment, the data storage medium can be inserted into a slot (such as slot 30 in FIG. 4) on the top 33 of the player/recorder 10.

FIG. 4 is a top view of the recorder/player of FIG. 3. FIG. 4 shows a slot 30 that is adapted to receive a removable data storage medium 55. The removable data storage medium can be inserted in and removed from the slot 30. The storage medium is capable of storing digital data. A data storage device (for example, data storage device 50 in FIG. 6) is incorporated into the recorder/player. The slot 30 of the player/recorder 10 corresponds to a receiving slot of the data storage device 50 for receiving an appropriate data storage medium 55.

In one embodiment, the storage medium 55 is a magnetic disk cartridge such as a POCKET ZIP™ manufactured by Iomega Corporation, Roy, Utah. However, other media, such as, optical or magneto-optical disks or data storage cartridges can be used without departing from the principles of the invention. It is contemplated that flash memory can also be used in accordance with the present invention. The data storage device 50 is capable of reading and writing digital data including, for example, video, audio and the like onto a data storage medium. In particular, in one embodiment, the data storage device is a disk drive such as the POCKET ZIP™ drive manufactured by the Iomega Corporation, Roy, Utah.

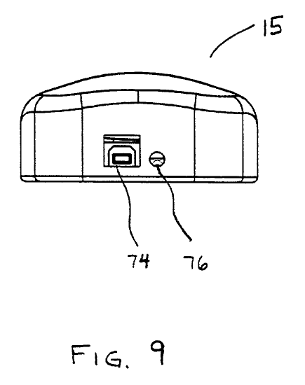

FIG. 5 is a bottom view of the player/recorder 10. As shown, an electrical connector 40 is provided in the player/recorder 10 to electrically connect the player/recorder 10 to the cradle 15. The player/recorder electrical connector 40 is adapted to mate with an electrical connector on the cradle (such as, for example, connector 70 in FIG. 9) when the recorder/player 10 is inserted into the cradle 15. As stated above, the player/recorder connector 40, when mated with the connector on the cradle, allows the transfer of data from an external data source through the cradle 15 to the player/recorder 10 and from the player /recorder 10 through the cradle 15 to an external data source. The player/recorder connector 40 also allows for the transfer of power

FIG. 5 also shows a headphone jack 45. The headphone jack 45 is adapted to mate with a headphone plug (not shown). When mated, the user can listen to audio data or the like in the player/recorder through headphones, external speakers or any other conventional listening device.

FIG. 6 is an exploded view of the player/recorder 10. FIG. 6 shows the layout of the internal components of the player/recorder 10. As shown, there are three layers within the housing 20 of the player/recorder 10. The first layer 62 comprises a Printed Circuit Assembly (PCA) 52. The second layer 63 comprises a data storage device 50, such as a disk drive, and the third layer 64 is a power source 54.

The first layer 62 is a PCA 52 that comprises a microprocessor (not shown) and a controller (not shown) which controls the disk drive 50. PCA 52 is connected (not shown in this figure) to buttons 25 or other activation switches on the exterior of the player/recorder and allows the user to control the function of the disk drive 50. In this manner, when a disk 55 is inserted in the disk drive 50, the user may control the functions (e.g. play, stop, reverse or forward) of the disk drive 50. PCA 52 is also connected to the display screen 22 that is protected by display screen shield 67.

PCA 52 also includes circuitry (not shown) that controls the data flow between the cradle 15 and the player/recorder 10 via the player/recorder connector 40. Although FIG. 6 does not show a connection between the PCA 52 and the disk drive 50, one skilled in the art would appreciate the appropriate connections that carrying out the functions described above.

The second layer 63 is a data storage device 50, such as a disk drive, and is adapted to receive a data storage medium 55 for reading and recording digital data such as music or other digital data to the data storage medium 55. Once inserted into the disk drive 50, the disk drive 50 operates on the data on the disk according to commands received from the PCA 52 (which may be controlled by the buttons 25). In one embodiment, the disk drive 50 reads the data and plays the data (in the form of audio music, for example) through the headphone jack 45 or an alternate speaker (not shown).

The third layer 64 is a power source 54 that provides power to the disk drive 50. In particular, the power source 54 powers the disk drive spindle motor (not shown), the PCA 52, the control circuitry (not shown) and control buttons 25. In one embodiment, the power source 54 is a rechargeable lithium polymer battery, however, other power sources can be used without departing from the scope of the invention. Preferably, the design of the battery is to maintain a low form factor and thus reduce the size of the overall player/recorder 10.

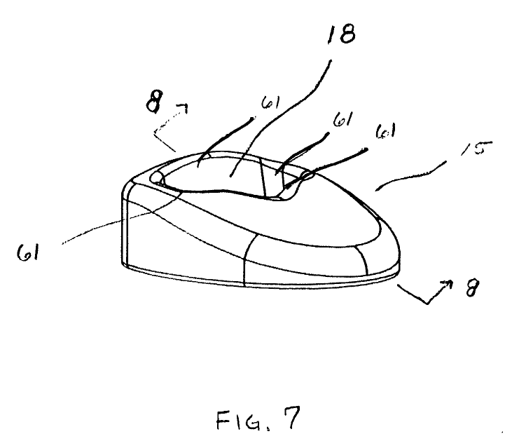

FIG. 7 is a perspective view of the cradle in FIG. 1 in accordance with the invention. FIG. 7 more clearly shows the overall structure of the cradle 15. The cradle 15 has a substantially wide bottom that provides support for holding the player/recorder as shown in FIG. 1. Additionally, the receptacle 18 has support walls 61 to aid in supporting the player/recorder.

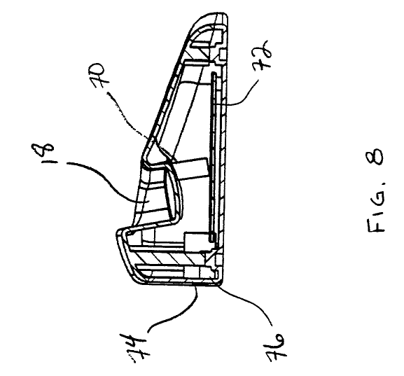

FIG. 8 is a cross section of the cradle 15 in FIG. 7 taken along sectional lines 8-8. Cradle 15 contains functional components from the player/recorder 10 that are not necessary for the player/recorder to play music. In one embodiment, as shown in FIG. 8, the components include a battery recharger and a USB jack. In this manner, these components can be removed from the player/recorder without affecting the player/recorder's ability to play digital music when the player/recorder has been removed from the cradle and is being used in a portable fashion. By moving these components to the cradle 15, the player/recorder has a smaller form factor, becomes lighter and easier to carry.

More particularly, FIG. 8 shows a cradle PCA 72. The cradle PCA 72 is adapted to recharge the player/recorder battery 54 when the player/recorder 10 is inserted into the cradle 15. In this manner, after using the player/recorder battery 54 to power the player/recorder while listening to music, for example, the user places the player/recorder in the cradle 15 and connects a power cord (with transformer, for example) (not shown) from an external power source (such as a wall outlet) to the power input jack 76 on the cradle 15. This connection serves to recharge the battery 54 in the player/recorder 10. It is contemplated that the cradle PCA 72 also contains components that power the player/recorder 10 while inserted in the cradle 15, monitor the battery capacity and other functions associated with battery charging.

The cradle PCA 72 also transfers data from an external data source (not shown) to the player/recorder 10 when the player/recorder 10 is inserted into the cradle 15 (and when the player/recorder connector 40 is connected to the cradle connector 70). The player/recorder 10 can then be removed from the cradle 15 and the player/recorder 10 can be used to access the data stored therein.

The cradle 15 also contains a Uniform Serial Bus (USB) jack 74. The USB jack 74 is adapted to mate with a USB cable (not shown) and can serve to send and/or receive data from an external data source, such as a personal computer. In this manner, a user can insert the player/recorder 10 into the cradle 15 and connect a USB cable from the cradle USB jack 74 to an external data source 17. Then, the user can download or otherwise transfer data from the external data source 17 to a data storage medium 55 within the player/recorder 10.

FIG. 9 is a rear view of the cradle 15. FIG. 9 more clearly shows the USB jack 74 and the power input jack 76. The USB jack 74 can be either Type A or Type B USB socket or any sort of connection port, such as, for example, serial, parallel, SCSI or firewire without departing from the scope of the invention. As stated above, in one embodiment, the external data source 17 is a personal computer. However, the external data source 17 can be any other device including a personal data assistant (PDA), phone or any other computing or telecommunications device without departing from the scope of the invention. It is contemplated that the external data source 17 can also be connectable either through a wireline or wireless connection to a network such as the Internet.

Power input jack 76 on cradle 15 is adapted to receive electrical power to power the cradle 15 and player/recorder 10. In one embodiment, the power input jack 76 receives 120 volt, 60 hertz AC power.

FIG. 10 is a top view of the cradle 15. FIG. 10 more clearly shows receptacle 18 that receives and holds player/recorder 10 and the shape of the base 101 of the cradle 15. As seen in this view, the base 101 of the cradle 15 is substantially circular with side walls 61 extending upward from the base 101 of the cradle 15 to define a receptacle 18. However, the shape of the base 101 can be square, rectangular or the like without departing from the scope if the invention. Additionally, the cradle connector 70 in the receptacle 18 is more clearly shown in this view.

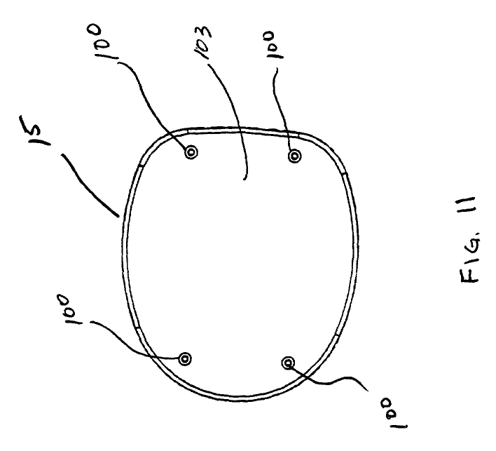

FIG. 11 is a bottom view of the cradle 15. A plurality of feet 100 extend from the bottom 103 of the cradle 15. As shown, four feet 100 extend from the bottom 103 of the cradle 15. The feet 100 serve to stabilize the cradle 15 while holding the player/recorder 10 and while the player/recorder 10 is inserted into and removed from the cradle 15. Preferably, the feet 100 are of a material having a high friction characteristic to prevent the cradle 15 from moving laterally along a surface (not shown). In one embodiment, the feet are made of rubber, however, other materials such as, for example, plastic may be used without departing from the scope of the invention.

As should now be understood the invention is directed to a digital audio player and recorder with cradle. Changes could be made to the embodiments disclosed above without departing from the broad inventive concepts thereof. For example, the invention could include an optical disk drive or the like without departing from the scope of the invention.

It is understood, therefore, that this invention is not limited to the particular embodiments disclosed, but it is intended to cover modifications within the scope of the present invention as defined by the appended claims.

What is claimed is:

1. The combination of a digital audio player and recorder for playing and recording digital data, and a cradle for receiving the digital audio player and recorder,
the digital audio player and recorder comprising:
a data storage device capable of receiving a data storage medium;
a printed circuit assembly (PCA) connected to the data storage device;
a housing enclosing the data storage device and the PCA; and
a first connector extending through the housing and connected to the PCA for transferring data between the cradle and the data storage device; and
the cradle comprising:
a receptacle adapted to receive the player and recorder;
a second connector adapted to detachably couple with the first connector; and
a third connector adapted to detachably couple with an external data source.

2. The combination of claim 1, wherein the data storage device comprises a disk drive, the disk drive capable of receiving a data storage cartridge or disk and reading and recording digital data to the data storage cartridge or disk.

3. The combination of claim 1, wherein the digital audio player and recorder further comprises a power source.

4. The combination of claim 3, wherein the power source comprises a rechargeable battery.

5. The combination of claim 3, wherein the power source is connected to the first connector.

6. The combination of claim 1, wherein the cradle further comprises a fourth connector adapted to detachably couple with a power supply.

7. The combination of claim 6, wherein the fourth connector is electrically connected to the second connector.

8. The combination of claim 1, wherein the digital audio player and recorder further comprises manually operable switches to control the operation of the data storage device.

9. The combination of claim 1 wherein the digital audio player and recorder further comprises a display, the display showing information relating to the digital data.

10. A cradle for receiving a digital audio player and recorder and transferring data to and from the digital audio player and recorder having a first connector, the cradle comprising:
a receptacle adapted to receive the player and recorder;
a second connector adapted to detachably couple with the first connector; and
a third connector adapted to detachably couple with an external data source.

11. The cradle of claim 10 wherein the second connector adaptively mates with the first connector on the digital audio player and recorder.

12. The cradle of claim 10 wherein the cradle further comprises:
a printed circuit assembly, the printed circuit assembly for performing communicative functions between the external data source and the digital audio player and recorder.

13. The cradle of claim 10, wherein the cradle further comprises a fourth connector adapted to detachably couple with a power supply.

14. The cradle of claim 13, wherein the fourth connector is electrically connected to the second connector.

15. A digital audio player and recorder comprising:
a data storage device capable of receiving a data storage medium;
a printed circuit assembly (PCA) connected to the data storage device;
a housing enclosing the data storage device and the PCA; and
a first connector extending through the housing and connected to the PCA for transferring data between a cradle and the data storage device.

16. The digital audio player and recorder of claim 15, wherein the data storage device comprises a disk drive, the disk drive capable of receiving a data storage cartridge or disk and reading and recording digital data to the data storage cartridge or disk.

17. The digital audio player and recorder of claim 15, wherein the digital audio player and recorder further comprises a power source.

18. The digital audio player and recorder of claim 17, wherein the power source comprises a rechargeable battery.

19. The digital audio player and recorder of claim 17, wherein the power source is connected to the first connector.

20. The digital audio player and recorder of claim 15, wherein the digital audio player and recorder further comprises manually operable switches to control the operation of the data storage device, and a display, the display showing information relating to the digital data.
